(19) United States
(12) Patent Application Publication
(10) Pub. No.: US 2019/0196925 A1
(43) Pub. Date: Jun. 27, 2019

(54) CONFIGURATION SYSTEM FOR CONFIGURING A TEST SYSTEM SUITABLE FOR TESTING AN ELECTRONIC CONTROL UNIT

(71) Applicant: dSPACE digital signal processing and control engineering GmbH, Paderborn (DE)

(72) Inventor: Tully ERNST, Paderborn (DE)

(73) Assignee: dSPACE digital signal processing and control engineering GmbH, Paderborn (DE)

(21) Appl. No.: 16/226,730

(22) Filed: Dec. 20, 2018

(30) Foreign Application Priority Data
Dec. 21, 2017 (DE) 10 2017 130 842.3

(51) Int. Cl. G06F 11/26; G06F 11/36; G05B 17/02; G06F 17/50

(52) U.S. Cl. CPC G06F 11/261; G06F 11/3672; G05B 17/02; G05B 2219/23451; G05B 2219/23445; G05B 2219/23446; G06F 17/5009

(57) ABSTRACT

A configuration system for configuring a test system suitable for testing an electronic control unit, wherein a configuration diagram has a plurality of hierarchy elements, and a hierarchy element either has one hierarchy element or multiple hierarchy elements or no hierarchy element. The hierarchy element has an identifier, and wherein a hierarchy element has port(s) or no port, and wherein at least one hierarchy element is assigned to a functional property of the test system to be configured, wherein in an expanded view mode, the hierarchy elements are displayed at least partially nested and the ports and identifiers are shown one below the other, wherein in an at least partially collapsed view mode, a first set of hierarchy elements is shown such that the identifiers are shown side by side, wherein the ports and identifiers remain visible and the hierarchical relationship of the hierarchy elements remains displayed.

This nonprovisional application claims priority under 35 U.S.C. § 119(a) to German Patent Application No. 102017130842.3, which was filed in Germany on Dec. 21, 2017, and which is herein incorporated by reference.

### BACKGROUND OF THE INVENTION

### Field of the Invention

The present invention relates to a configuration system and a method for configuring a test system suitable for testing an electronic control unit.

### Description of the Background Art

The present invention is concentrated on the development of control devices, such as they are used in the automotive or aerospace industries for controlling technical systems, such as motors or brakes. In particular, the present invention relates to test systems used in the development process of control units.

The development of control units has become a highly complex process. In particular, new control units or new control functions should be tested as early as possible in the development process to review their overall functionality and to specify the further direction of development. Towards the end of the development process, it is important to test the already well-developed control unit as comprehensively as possible in order to carry out necessary modifications based on the test results before the control unit is launched or is series-produced, so that it functions as desired under all circumstances in later operation.

For the testing of control units, the methods hardware-in-the-loop simulation (HIL simulation) and rapid control prototyping (RCP) are known. In HIL simulation, an electronic control unit is connected to a test system (HIL simulator), on which, for example, a software model of the system to be controlled or regulated by the control unit is executed. The software model is also referred to as an environment model. The test system thereby simulates the physical environment of the later application for the control unit. With RCP, on the other hand, a software model of a control unit to be developed or improved is executed on the test system. In the case of RCP, a technical system externally connected to the test system is regulated or controlled via the test system by means of the model executed on the test system.

The test of a (series) control unit used in the final product is the endpoint of a plurality of upstream development steps of control or regulation that is to be implemented on the control device, wherein these development steps are usually described by the so-called V-model or V-cycle. At the outset of the controller development essential for the functioning of many technical systems, mathematical modeling of the control algorithm is available on a computer with a mathematical and graphic modeling environment, wherein the controller can be understood to be part of the control unit. In addition, the environment of the control unit is mathematically modeled because the interaction of the controller on the control unit with the process to be controlled is of interest. In these functional mathematical examinations, simulation in real time is mostly not required (offline simulation).

In the next step, with the aid of Rapid Control Prototyping, the previously designed control algorithm is transferred to a powerful, mostly real-time capable hardware which is connected with the actual physical process via suitable I/O interfaces, so for example, with an automotive engine. This real-time capable hardware usually has nothing to do with the serial control unit that is later used; the object here is to prove the basic functionality of the previously designed control in practice.

In a further step, in the context of the automatic serial code generation, the control is implemented on the target processor, which later is probably actually used in the serial controller. The target hardware thus approximates the serial controller in this step, but is not identical to the serial controller.

In a further step, the series control unit, which usually exists only at a late development stage, is reviewed in the context of a hardware-in-the-loop (HIL) test. Here, the (serial) control device physically existing in this step is connected with a powerful simulation computer, often simply referred to as a simulator or test system, by means of its physical control unit interface. The simulator simulates the required variables of the real control unit to be tested and swaps input and output variables with the control unit. The pins of the physical control unit interface of the control unit are connected with the simulator via a wiring harness. This way, it is possible to simulate all the required variables, such as of a motor vehicle engine—if necessary, the entire motor vehicle including engine, drive train, chassis and driving distance—in the simulation environment and to safely check the behavior of the control unit in interaction with the simulation environment.

To configure test systems such as HIL or RCP systems, often configuration systems are used which may also contain, for example, configuration diagrams. The configuration adjusts the test system such that software models of technical systems can be executed on the test system and communicate electronically via the input/output interface of the test system with devices (systems under test) connected to the test system. The software models are created in dedicated modeling environments that are specifically tailored to the modeling requirements.

The known configuration systems or configuration diagrams have the disadvantage that the configuration of the test system properties is time consuming and complicated in certain application scenarios.

The configuration diagrams often have a high number of hierarchy elements that are deeply nested. A configuration system that has a large number of hierarchy elements is known, for example, from U.S. Pat. No. 7,877,153, which is incorporated herein by reference. In this configuration system, the hierarchy elements are shown in an expanded view mode and a collapsed view mode, wherein in the collapsed view mode, the corresponding hierarchy element is only displayed by a block containing the name of the collapsed hierarchy element, which no longer allows conclusions about which ports the displayed hierarchy element has. The selection of a collapsed view mode is a way for the editor of the configuration system to reduce complexity when it comes to the large number of hierarchy elements of the configuration system, and to hide information of less interest for the editing process. However, with the change of the view mode, a relatively large amount of information may be hidden, so there may be times when frequent switching between the view modes becomes necessary.

### SUMMARY OF THE INVENTION

It is therefore an object of the present invention to provide a configuration system with which the complexity of a configuration diagram can be reduced, without giving up important information such as the existing ports, so that the editing of such a configuration diagram is facilitated by the configuration system.

According to an exemplary embodiment of the invention, a configuration system is provided for configuring a test system suitable for testing an electronic control unit, comprising a computer with a display device, wherein a configuration diagram is displayed by means of the display device, wherein the configuration diagram comprises at least one hierarchy element, and a hierarchy element can have sub-hierarchy element(s), for example, one hierarchy element or a plurality of hierarchy elements or no hierarchy element and wherein a hierarchy element has an identifier and a port or multiple ports or no ports, and wherein at least one hierarchy element is associated with the configurational functional property of the test system, wherein in an expanded view mode, the hierarchy elements are shown at least partially nested, and the ports and identifiers are shown either below each other or side by side, and wherein in an at least partially collapsed view mode, a first set of hierarchy elements is shown either side by side or one below the other, wherein the ports and the identifiers remain visible and the hierarchical relationship of the hierarchy elements remains displayed.

The hierarchy elements may be a variety of model components, which, for example, represent mathematical functions that in summary produce the abstract mathematical model of the test system to be configured. These are shown, for example, in block diagrams or tree diagrams describing the physical-technical functionality of the technical system with the rules of mathematics (transfer functions, look-up tables and much more). A model of a technical system is, for example, a mapping of a technical system existing in reality, which is to be simulated, for example, a control system with an electronic processing unit and input and output devices connected to this processing unit. Such a technical system can be very complex, if, for example, it maps a motor vehicle control unit and/or the complete, simulated environment of a motor vehicle. In this case, the model has a large number of model components that interact with each other in a functional relationship and exchange data of different types. In addition, there is a hierarchical dependency between the model components that are expediently mapped by means of a graphical representation of the hierarchy, for example, by hierarchy elements. This can be done for example by a nested or tree-like representation of the hierarchy elements.

In this context, ports can be understood to be representations for inputs and outputs, by means of which the individual model components or hierarchy elements can be interconnected. These in turn represent connections within the test system, for example, they represent physical connections between subcomponents of the test system, such as a cable between the controller and the simulator, or logical connections like the link between a variable of the model and an input/output functionality of the simulator. In order to ensure a distinction and assignability of the hierarchy elements, these carry identifiers which serve to identify the illustrated model component. This can be a type of numbering or a string of characters suitable for identification.

Hierarchy elements can contain one or more ports, as well as other subordinate hierarchy elements. A port does not have to be mandatory. As a rule, if no subordinate hierarchy element is present, the hierarchy element has at least one port. In contrast, higher-level hierarchy elements often have no ports, but only subordinate hierarchy elements.

In an expanded view mode, the hierarchy elements can be shown nested in one another. In this case, the hierarchy elements can be arranged such that the identifiers of the hierarchy elements are arranged one below the other. For models of higher complexity, a downwardly elongated representation is thus obtained, which prevents a quick overview. Therefore, in an at least a partially collapsed view mode, a part of the higher-level hierarchy elements can be arranged such that the identifiers are now located next to the hierarchy elements, i.e., the presentation is collapsed to some extent. This way, the hierarchical relationship between the hierarchy elements remains recognizable, and the ports of the elements remain visible.

An advantage of the configuration system according to the invention for configuring a test system suitable for testing an electronic control unit is that the configuration diagram can be displayed in a collapsed view mode in a space-saving manner, without needing to forgo the overview of the hierarchical relationships between the hierarchy elements.

The configuration diagram can be displayed in a block-based structure, i.e., it is displayed as a block diagram. The hierarchy elements in this example are displayed as blocks and the hierarchical relationship between the hierarchy elements are displayed as a nested arrangement. In an expanded view mode, the identifiers of the blocks that belong to the first set are shown next to the remaining blocks. Each block of the first set has the vertical extent of its subordinate blocks. That way, the representation of hierarchical relationships continues to be possible, and the representation of the configuration diagram is clearly visible and has a reduced vertical extension. This makes scrolling or using larger display devices or a higher resolution superfluous.

Further scope of applicability of the present invention will become apparent from the detailed description given hereinafter. However, it should be understood that the detailed description and specific examples, while indicating preferred embodiments of the invention, are given by way of illustration only, since various changes, combinations, and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a configuration diagram in an expanded view mode;

FIG. 2 is a configuration diagram in a collapsed view mode, which is known from the prior art;

FIG. 3 is a schematic representation of a configuration diagram in a collapsed view mode corresponding to a first embodiment of a configuration system for configuring a test system suitable for testing an electronic control unit;

FIG. 4 is a schematic representation of a configuration diagram in an expanded view mode corresponding to another embodiment of a configuration system for configuring a test system suitable for testing an electronic control unit;

FIG. 5 is a schematic representation of a configuration diagram in a partially collapsed view mode according to a further embodiment of a configuration system for configuring a test system suitable for testing an electronic control unit;

FIG. 6 is a schematic representation of a configuration diagram in a partially collapsed view mode according to a further embodiment of a configuration system for configuring a test system suitable for testing an electronic control unit;

FIG. 7 is a schematic representation of a configuration diagram in a partially collapsed view mode according to a further embodiment of a configuration system for configuring a test system suitable for testing an electronic control unit;

FIG. 8 is a schematic representation of a configuration diagram in a completely collapsed view mode according to a further embodiment of a configuration system for configuring a test system suitable for testing an electronic control unit;

FIG. 9 is a schematic representation of a test system;

FIG. 10 is a schematic representation of an embodiment of a configuration system; and

FIG. 11 is a schematic representation of an example of a computer with a display device

### DETAILED DESCRIPTION

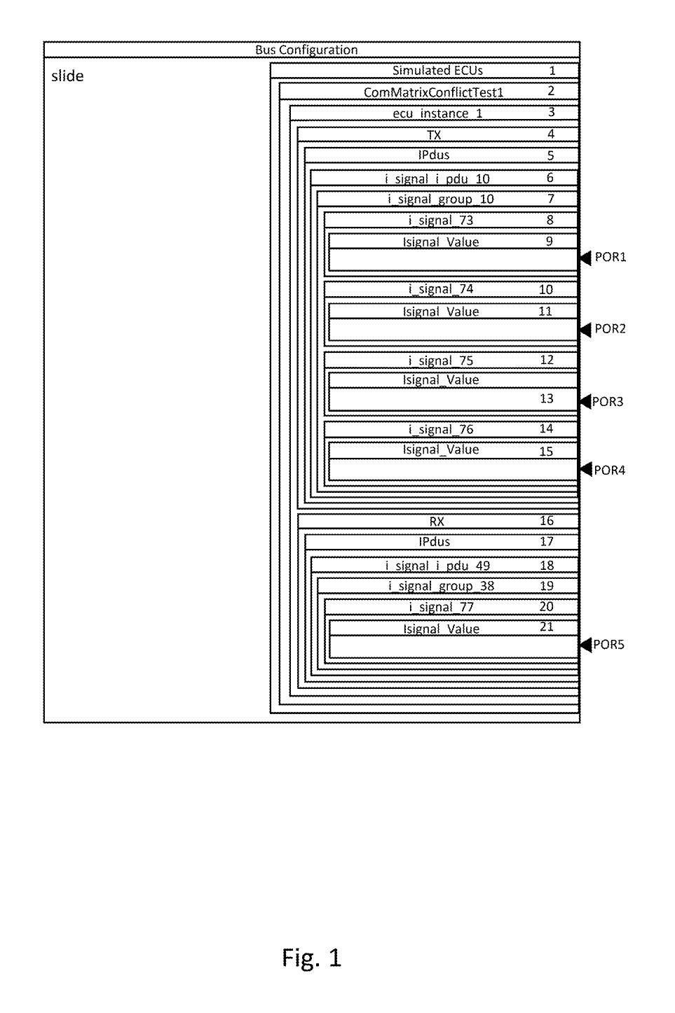

The illustration of FIG. 1 shows a configuration diagram DIA in an expanded view mode, in which hierarchy elements are shown according to their hierarchical structure. The hierarchy elements HIE are numbered in the drawing of FIG. 1 with the numbers 1 to 21. The hierarchy elements can contain one or more additional hierarchy elements, which result in hierarchy levels. For example, hierarchy element with the number 3 has two, subordinate hierarchy elements with the numbers 4 and 16. In contrast, the hierarchy element with the number 1 only has one more hierarchy element (number 2), while the hierarchy element with the number 9 does not contain any other hierarchy elements. Each hierarchy element has an identifier that allows the user to more easily identify the element and can provide an indication of the typing of the hierarchy element according to the technical property of the test system to be configured with the element. More information about this can be found in FIG. 10 and in the description of FIG. 10. In FIG. 1, exemplary identifiers have been selected for the displayed hierarchy elements: Number 1 “Simulated ECUs”, number 2 “ComMatrixConflictTest1”, number 3 “ecu_instance_1”. The further assignment of identifiers to the hierarchy elements with the numbers 4-21 can be found accordingly in FIG. 1.

Furthermore, some hierarchy elements with the numbers 9, 11, 13, 15 and 21 have the ports POR1, POR2, POR3, POR4, POR5 in the illustrated example. For example, the ports are used to drag connections between model components of the underlying software model and act as an input/output interface between the model components.

The nested representation shows the hierarchical structure underlying the hierarchy elements without further user interaction with the configuration diagram. However, in the vertical direction, quite a lot of space is needed if today's models of higher complexity are to be mapped. For the user to get an overview of the diagram, he or she must move the screen, also referred to as “scrolling”.

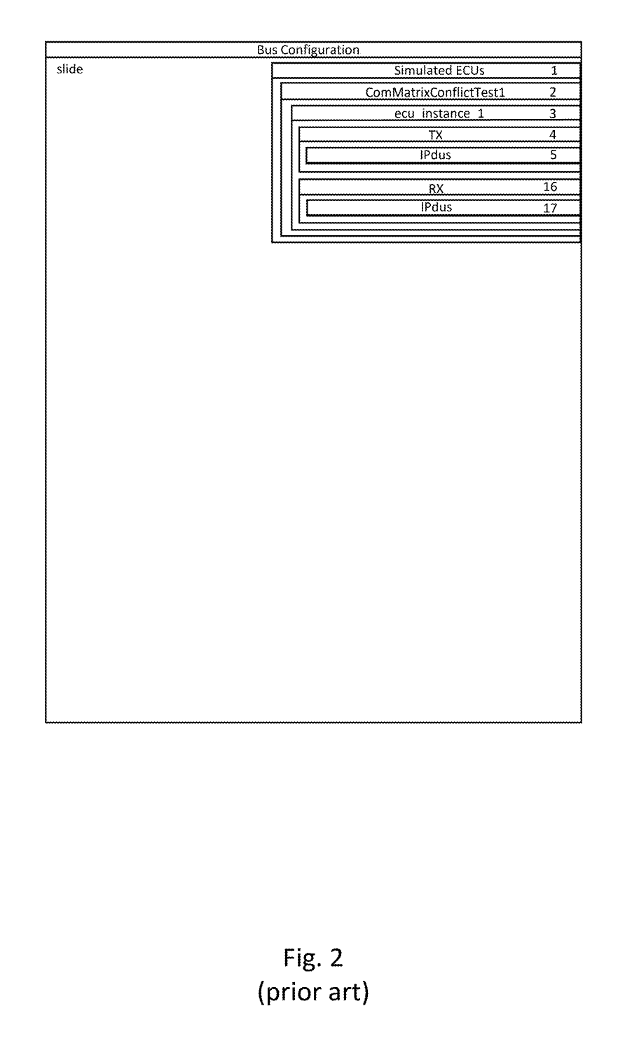

In FIG. 2, therefore a reduction in complexity common in the prior art is shown in favor of clarity. The underlying example is the same as for FIG. 1, only here, all hierarchy levels below hierarchy elements number 5 and number 17 were removed from the illustration. However, the reduced representation also results in a reduction of the available information—the lower hierarchy levels and the ports present in the example are no longer recognizable.

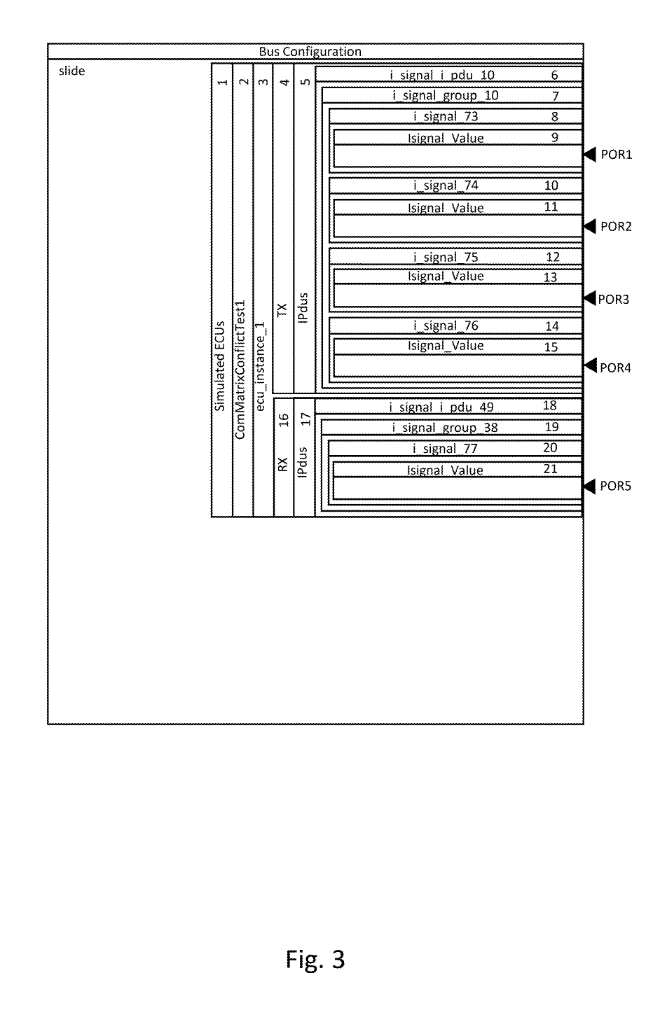

This problem is solved by the invention; FIG. 3 accordingly shows an example of a configuration diagram DIA in a collapsed view. Here, as in the example of FIG. 2, a reduction below the hierarchy elements 5 and 17 was selected. However, the solution approach of the invention is not the mere omission of the corresponding hierarchy elements from the representation, but also the reduction in complexity in the vertical direction to improve the overview, and at the same time to maintain all the ports and hierarchy elements, including their hierarchy levels. In the example of FIG. 3, the hierarchy elements with the numbers 1-5 and 16-17 have been removed from the vertical dimension. These hierarchy elements are arranged in collapsed view mode next to the subordinate hierarchy elements 6-15 and 18-21, which have remained in the original display form. The extent of the hierarchy elements 1-5 and 16-17 in the vertical direction corresponds to the vertical extent of the corresponding subordinate hierarchy elements. For example, the vertical extent of the hierarchy element 17 corresponds to the extension of the subordinate and nested hierarchy elements 18-21. At the same time, ports 1-5 remain visible, as well as the complete information about the hierarchical structure.

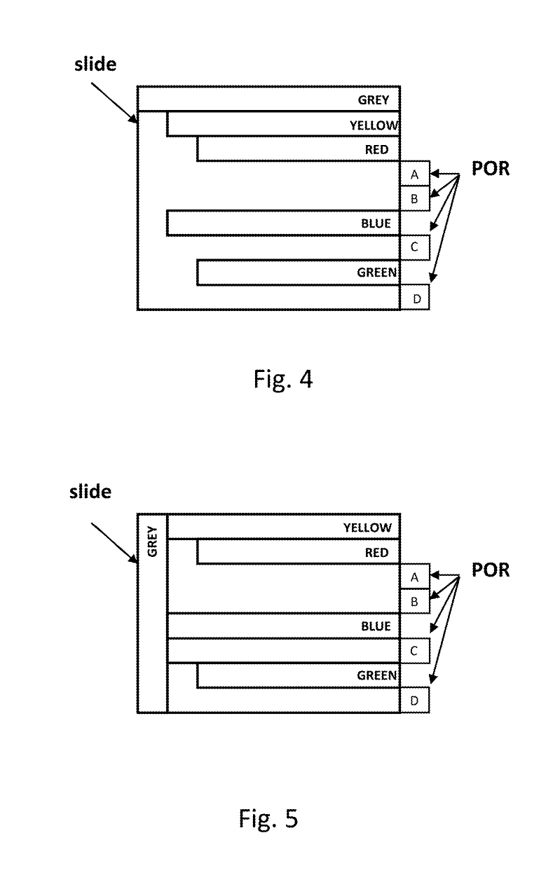

FIGS. 4-8 clarify the underlying principle in an exemplary manner. Here, an abstracted form was chosen to increase clarity. Thus, FIG. 4 shows the fully expanded configuration diagram with the hierarchy elements GRAY, YELLOW, RED, BLUE and GREEN. The hierarchy element RED also has two ports POR (A and B), BLUE and GREEN each have a port (C and D). In this example, the hierarchical relationship between the hierarchy elements is mapped by the horizontal extent of the hierarchy elements, similar to what is shown in FIGS. 1-3. GRAY has all other hierarchy elements, YELLOW has RED and BLUE has GREEN.

In FIG. 5, a first stage of the collapsed view mode is shown—here, the change in the view mode was performed starting with the hierarchy elements below GRAY. The hierarchy element GRAY now extends vertically along all the other hierarchy elements and the vertical extent of the configuration diagram is reduced.

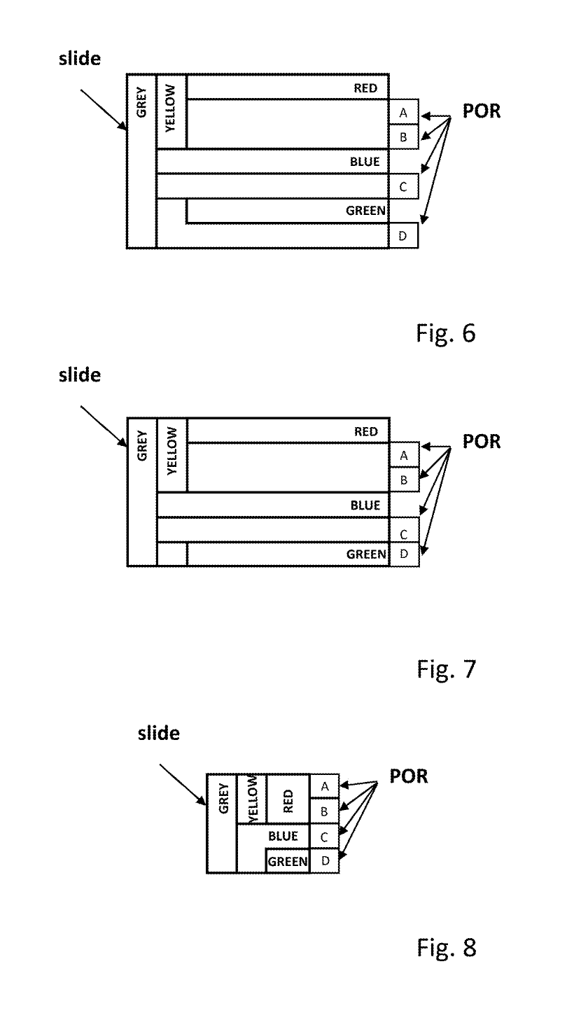

In FIG. 6, the change was performed below the hierarchy element YELLOW so that YELLOW now extends vertically along the hierarchy element RED with the two associated ports A and B. Accordingly, in FIG. 7, a collapse was performed below the hierarchy element GREEN, and in FIG. 8, below the hierarchy elements BLUE and RED. In FIG. 8, the maximum possible reduction is now attained by the collapsed view mode. The configuration diagram is now very compact and continues to show the complete hierarchical structure.

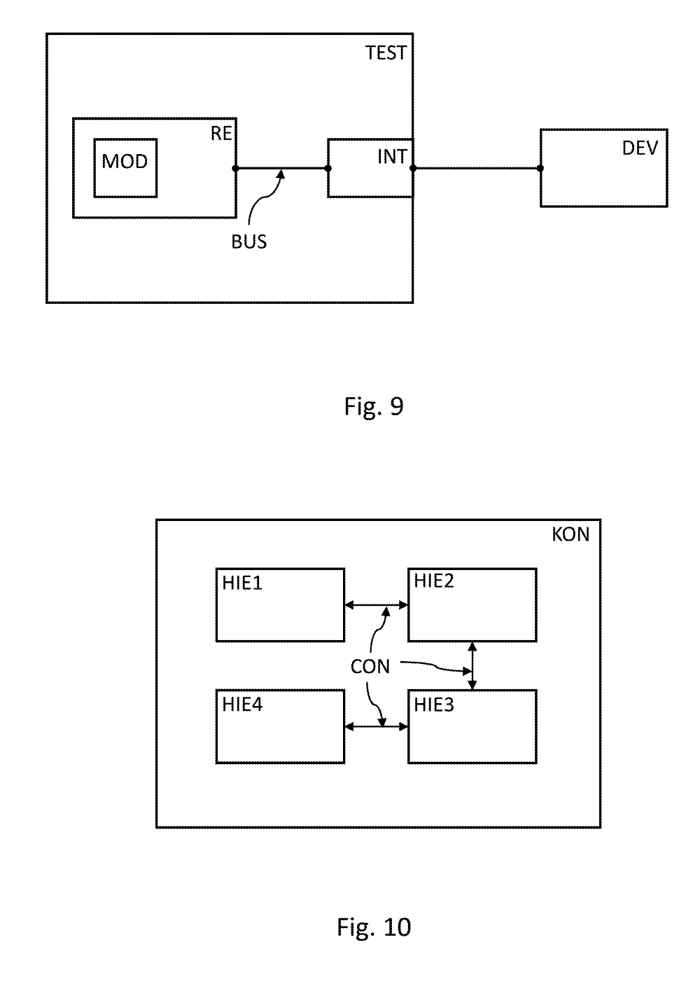

FIG. 9 shows a test device TEST on which a software model MOD of a technical system is executed on an electronic processing unit RE, wherein the software model or the processing unit communicates via an input/output interface INT of the test device, and an internal data connection BUS communicates with a device DEV connected to the test device. A processing unit can be, e.g., a processor, an FPGA or an embedded PC. Communication with the test device can take place by means of the transmission of analog or digital electrical signals. The test device can include various hardware units (e.g., plug-in cards), which form the input/output interface INT. The input-output interface and the electronic processing unit RE form a coherent system, but can also be spatially separated and connected to one another by electronic links.

The test device TEST can be, e.g., a “Hardware in the Loop” (HIL) simulator. The test device TEST can also be a “Rapid Control Prototyping” (RCP) system. However, the test device can also be a device that is suitable for the execution of HIL tests or RCP tests, in that a model of a technical system can be executed in the test device and that this model can exchange data via input/output interfaces with a device under test which is connected to the test device, such as a control unit, wherein in particular in this data exchange, the reaction of the test device to data resulting from the model, which is transmitted to the control unit, e.g., for example in the form of electrical signals, is analyzed.

A software model MOD, so e.g., a model of a technical system, can be present by way of example in the form of a software model, which is specified by a source code, e.g., in a high-level language such as C, C ++, or in a machine language such as Assembler or executable machine code. By means of a technical model, unlimited systems can be modeled in order to virtually simulate them. For example, a model of an engine may be present as a software, wherein the software is programmed in such a way that during simulation, in this case an execution of the model on a CPU or an FPGA, input parameters are processed by the software and output values are generated as a function of the input parameters and the characteristics of the model. An input parameter can be, e.g., the voltage applied to a throttle valve of a gasoline engine and output values in this regard could be the resulting opening angle of the throttle valve, the fuel consumption and/or a torque resulting from the crankshaft. However, the model can also be a model of a control device to be tested or developed. Generally, the software model can be understood to be an algorithm for the control, regulation or simulation of the behavior of a technical system.

The illustration of FIG. 10 shows a schematic representation of a configuration system KON which has several hierarchy elements (HIE1, HIE2, HIE3, HIE4), which are connected to connecting lines CON for configuring the test device TEST.

For example, the hierarchy elements can configure properties and functionalities of the test device, in particular, of the input/output interfaces and/or the model interfaces or internal data connections 107. Exemplary properties include interface types, voltage/current ranges, units, unit scaling, data types, duty cycles, frequencies and/or error injections. These properties can be specified by parameters, for example, by a predetermined selection of several parameters or by a free input option for the parameters. These properties can be transferred to the test device by means of the configuration system, where they can be stored and thus provide a configuration of the test device according to the properties. This configuration process can also take place indirectly, e.g., by a code generation according to the properties, and/or a subsequent compilation of the generated code, a transfer of the code, or of the compiled code, to the test device, and the execution of the compiled code on the test device. The storage of the properties on the test device can thus also be done by means of a source code or binary code.

The hierarchy elements may be assigned properties of the test device with associated parameters of the properties, and by means of the parameters, communication, i.e., in particular the functionality between the connected device and the software model, can be configured. In a graphical configuration environment, the individual hierarchy elements can also be connected to each other in order to perform a configuration of the test device. Different hierarchy elements can be connected, or in others words, associated or assigned, by means of the connecting lines CON. These assignments can configure different hardware components of the test device, such as processors, FPGAs, input-output boards, storage media and the like, so that they exchange data with each other, i.e., receive and send electrical signals.

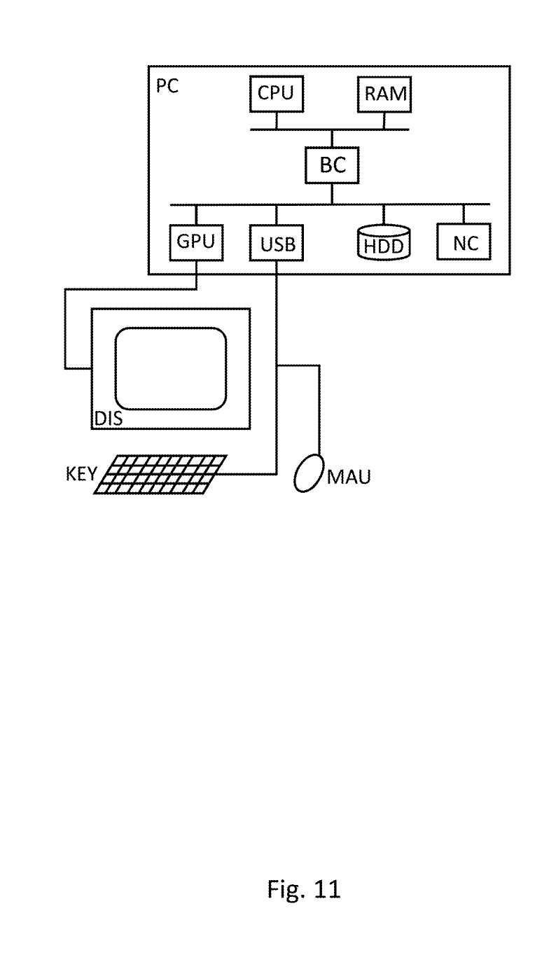

In the illustration of FIG. 11, a computer PC with a display device DIS and HMI devices such as a keyboard KEY and a mouse MAU are shown. A configuration system for configuring a test system suitable for testing an electronic control unit can comprise such a computer in one embodiment.

The computer PC comprises at least one electronic processing unit CPU with one or more cores, a random access memory RAM and several peripheral devices connected to a local bus system, e.g., PCI Express, which exchanges data with the CPU unit by means of a bus control unit BC. The peripheral devices include, for example, a graphics card GPU, a bus control unit USB for connecting other peripheral devices, a non-volatile main memory HDD, for example, a hard disk or a semiconductor hard disk, and a network interface NC. In one embodiment, instructions are stored in the non-volatile main memory by means of which the computer carries out a method according to one or more of the claimed embodiments by means of an electronic processing unit.

The computer can comprise one or more servers, which include one or more processing units. The servers are then connected via a network to a client computer, which comprises a display device. The configuration system can then be completely or partially executed on a remote server, such as on a cloud computing system.

The invention being thus described, it will be obvious that the same may be varied in many ways. Such variations are not to be regarded as a departure from the spirit and scope of the invention, and all such modifications as would be obvious to one skilled in the art are to be included within the scope of the following claim.

What is claimed is:

1. A configuration system for configuring a test system to test an electronic control unit, the configuration system comprising:
a computer with a display device; and
a configuration diagram displayed via the display device,
wherein the configuration diagram has a plurality of hierarchy elements, and a hierarchy element of the plurality of hierarchy elements includes either one sub-hierarchy element or multiple sub-hierarchy elements or no sub-hierarchy element, and
wherein the hierarchy element has an identifier, and wherein the hierarchy element has a port or multiple ports or no port,
wherein at least one hierarchy element is assigned to a functional property of the test system to be configured,
wherein, in an expanded view mode, the hierarchy elements are shown at least partially nested and the ports and identifiers are shown one below the other,
wherein, in an at least partially collapsed view mode, a first set of hierarchy elements is shown in such a way that the identifiers are displayed side by side, and
wherein the ports and the identifiers remain visible and the hierarchical relationship of the hierarchy elements remains displayed.

2. The configuration system according to claim 1, wherein the test system is a HIL or RCP simulator and a software model of a technical system is executed on the simulator, and the software model exchanges status and/or control data on the simulator with the connected electronic control unit by means of an I/O interface.

3. The configuration system according to claim 1, wherein the hierarchy elements are shown as blocks.

4. The configuration system according to claim 1, wherein the identifiers of the blocks that represent the hierarchy elements of the first set are arranged side by side, and each higher-level block has the vertical extension of all the blocks subordinate to this block.

5. The configuration system according to claim 1, wherein the hierarchy elements in the expanded view mode are displayed at least partially nested, and the ports and identifiers are shown side by side, and wherein in the at least partially collapsed view mode, the first set of hierarchy elements is shown such that the identifiers are shown one below the other, wherein the ports and identifiers remain visible and the hierarchical relationship of the hierarchy elements remains displayed.

6. The configuration system according to claim 6, wherein the blocks representing the hierarchy elements of the first set are arranged one above the other and each higher-level block has the horizontal extent of all subordinate blocks.

7. A method for a configuration of a test system to an electronic control unit on a computer with a display device, wherein the computer has a configuration diagram, wherein the configuration diagram comprises a plurality of hierarchy elements and a hierarchy element of the plurality of hierarchy elements includes either one sub-hierarchy element or multiple sub-hierarchy elements or no sub-hierarchy element, the method comprising:
assigning at least one hierarchy element to a functional property of the test system to be configured, wherein a hierarchy element has an identifier, and wherein a hierarchy element has a port or multiple ports or no port;
displaying the configuration diagram on the display device;
displaying the hierarchy elements in an expanded view mode at least partially nested;
displaying ports and identifiers arranged one below the other in the expanded view mode; and
displaying a first set of hierarchy elements in sum in a collapsed view mode,
wherein, in the collapsed view mode, the identifiers of the first set are hierarchy elements displayed side by side, and the ports and the identifiers remain visible and at the same time, the hierarchical relationship of the hierarchy elements remains displayed.
